(19) United States
(12) Patent Application Publication
(10) Pub. No.: US 2013/0215603 A1
(43) Pub. Date: Aug. 22, 2013

(54) LED DEVICE HAS BUILT-IN REMOVABLE LED-LIGHTS.

(71) Applicant: Tseng-Lu CHIEN, Walnut, CA (US)

(72) Inventor: Tseng-Lu CHIEN, Walnut, CA (US)

(21) Appl. No.: 13/402,247

(22) Filed: Feb. 22, 2012

(51) Int. Cl. F21L 4/08; F21L 4/02

(52) U.S. Cl. 362/183; 362/184

(57) ABSTRACT

The current invention for The LED device has build-in removable LED-Unit(s) which the main object has 1^{st} illumination with its own functions and more than one LED-unit(s) has its own illumination while people operate it. This allow the one LED device has more than one of the said LED-light(s) with pre-determined function(s), effect(s), performance for illumination to keep the said all LED device become more practically device to offer at least more than one illumination from one device than ever while has power fail, emergency, hazard condition(s) or daily use purpose.

### BACKGROUND

The current invention is co-inventor's Division filing of the U.S. Pat. No. 8,083,376 and co-inventor's prior art U.S. Pat. No. 6,179,431 6 EL flash light. The current invention also is continuously of co-pending filing for Ser. No. 12/938,628 LED light fixture has outlets and removable LED unit(s) and continuously filing for Ser. No. 12/887,700 (now is U.S. Pat. No. 8,083,392)

The current market LED light including the flash light, Power Fail light, Light bar, light device has LED-element(s) as light source to replace the out-of date Incandescent Bulbs for less power consumption, compact size, long burn time, long life for light source . . . etc.

Basing on these power saving, compact size, longer burn-time while applied LED as light source instead of out-of-date incandescent bulbs, so the size of the flash light, power fail light, light bar, light device become very small. All these categories products in market become very compact such as cigarette lighter size, or mini size of hot-dog size which are too small and normally can not find where are the flash light, or power fail light, or light bar, or LED device while people want to use.

However, The categories of flash light, power fail light, light bar, LED device people still think the old bulky size as the flash light, power fail light, light bar, or LED device such as house phone still keep same size, no one make like mini size hot-dog size because the people head size from ear to mouth still not reduce to mini size hot-dog. Same of Flash light, Power fail light, Light Bar, LED device, the traditional size with bulky size which are fit for people hand size and good for palm holding to let people feel safety while using these device(s) on emergency or some hazard time. The categories of flash light, power fail light, light bar, LED device has traditional image deep inside human memory so it is not good to make compact size at all.

The current invention apply the LED element(s) as light source to keep the power saving, long burn time, light source long life . . . etc. however, keep the same bulky size and make one housing with more than one piece of LED lights which may said at least one big one for adult and at least one small LED light for children or kids for their smaller hand to hold it, so can keep the traditional bulky size but with build-in at least more than one LED lights.

The removable LED-light build in the said Flash light, Power fail light, LED bar, LED device. The said at least one of the LED-light can removable from the said main object at any time to offer illumination which the said main-object and removable-unit(s) has its power source same as main-object powered by any combination of the following parts & accessories from rechargeable batteries, non-rechargeable batteries, energy storage means, solar power, chemical power, mechanical power, generator means, mechanical or electric means to generate the power means, motion electric generator(s), or any kind of means which can get power to make the said LED-elements for illumination under pre-determined effects, functions, performance.

However, the current invention is different the inductive charging LED candle light sets which lack of the said main-object has illumination function under predetermined design for period of time. It just offer a inductive recharging base and has several LED candle light(s) sit on position to recharge the plurality of LED candle light(s). Hence, this is not has (1) Main-Object illumination at all. The inductive charging system need some parts & accessories inside the main object and other LED-light(s) so can use magnetic field to charge the energy storage means to supply the electric signal to the said LED-light though circuit means, conductive means and related parts & accessories.

Hereafter on the drawing, details discussion and claims will list the current inventions more features below:

It is appreciated the current invention has all above discussed co-pending or issued patent's drawing, details description and content are still been the parent filing of the current invention and all such drawing, detail description, contents should be still fall within the scope of the current invention and not limited to the current drawing, details description, content.

### DRAWING

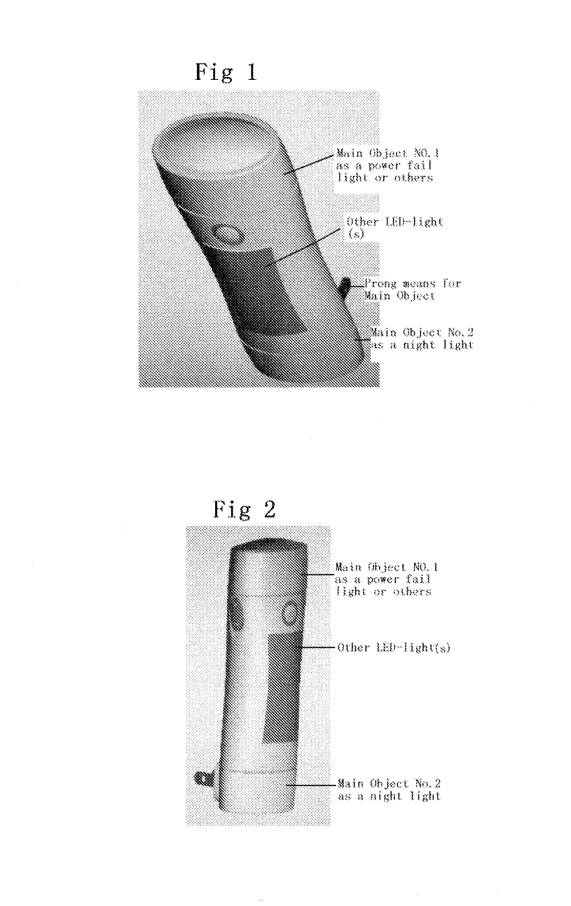

1. From FIG. 1 and FIG. 2 disclosure the LED device has build-in removable LED-light(s) which for preferred embodiment for a LED power fail Night light which has extractable prong means to connect with home electricity system to get power to make the said below LED night light turn on by photo sensor control and the main-object illumination is a top flash light which will turn on while power fail automatically, the has build-in movable LED-light(s) is the center piece which can turn-on and turn-off by desired sensor means, switch means, motion sensor means, remote control means as discussed on above background and following details descriptions content.

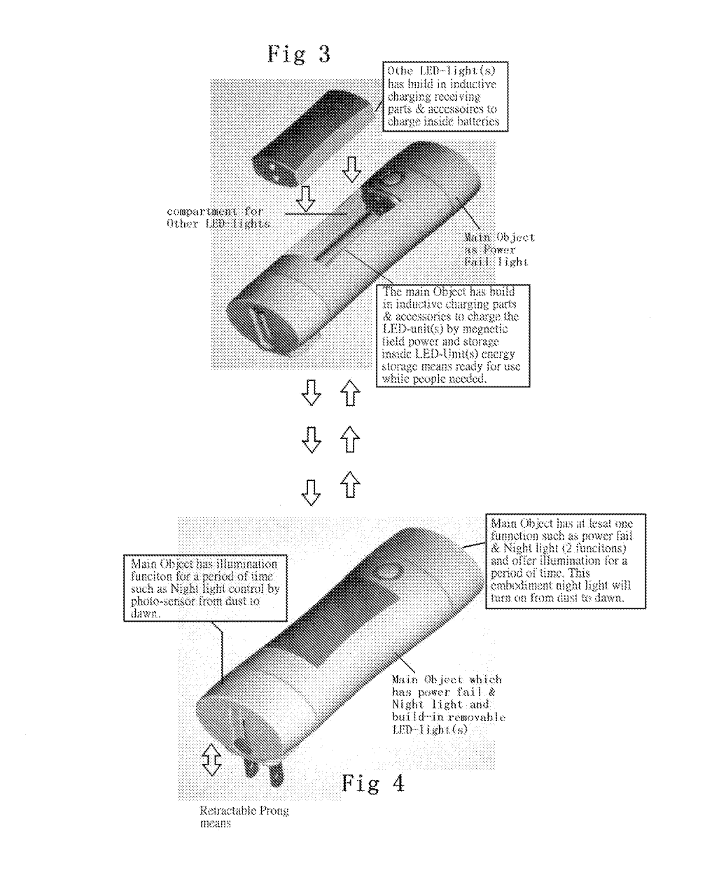

2. From FIG. 2 and FIG. 3 disclosure the one of the preferred construction for the said main-object with its illumination design and the said has build-in movable LED-unit(s) assembly and dis-assembly from the main-object. It also disclosure the idea for inductive charge system between the main object and other LED-light(s).

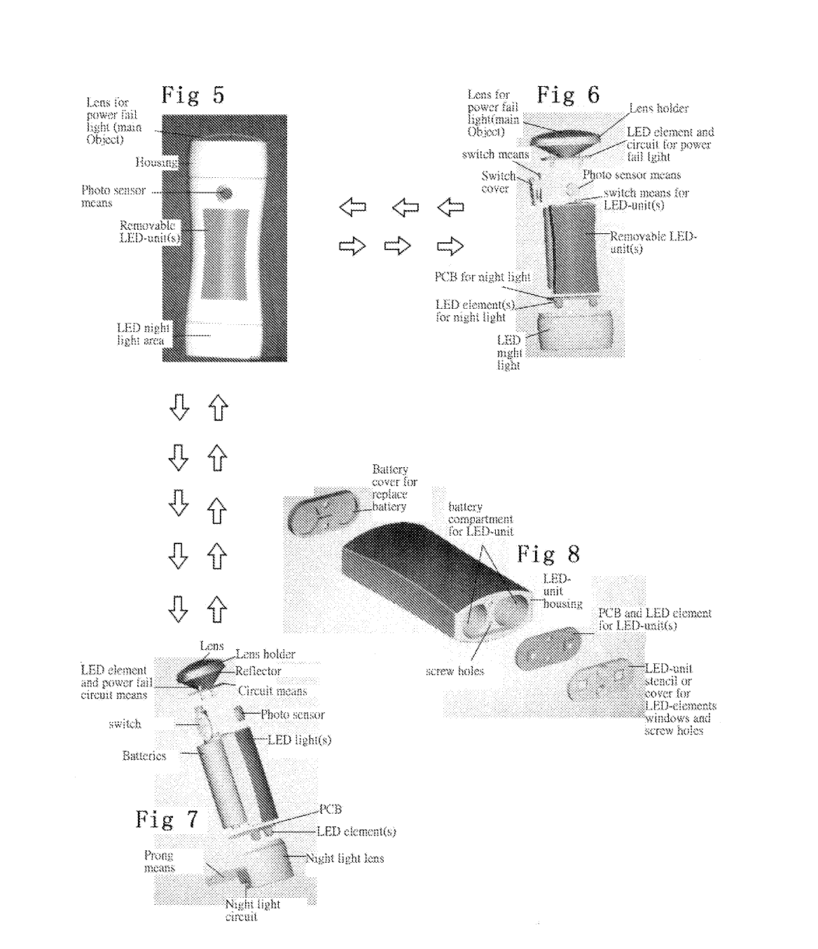

3. From FIG. 5, FIG. 6, FIG. 7, FIG. 8 disclosure all details construction of the main object and has build-in removable LED-light(s). The said main may in a power fail night light, emergency light with build in night light which has all parts and accessories to show the preferable details and construction. The alternative or replaceable or equivalent function parts & accessories of above discussion, prior arts, co-pending skill or method still fall within the current scope of invention.

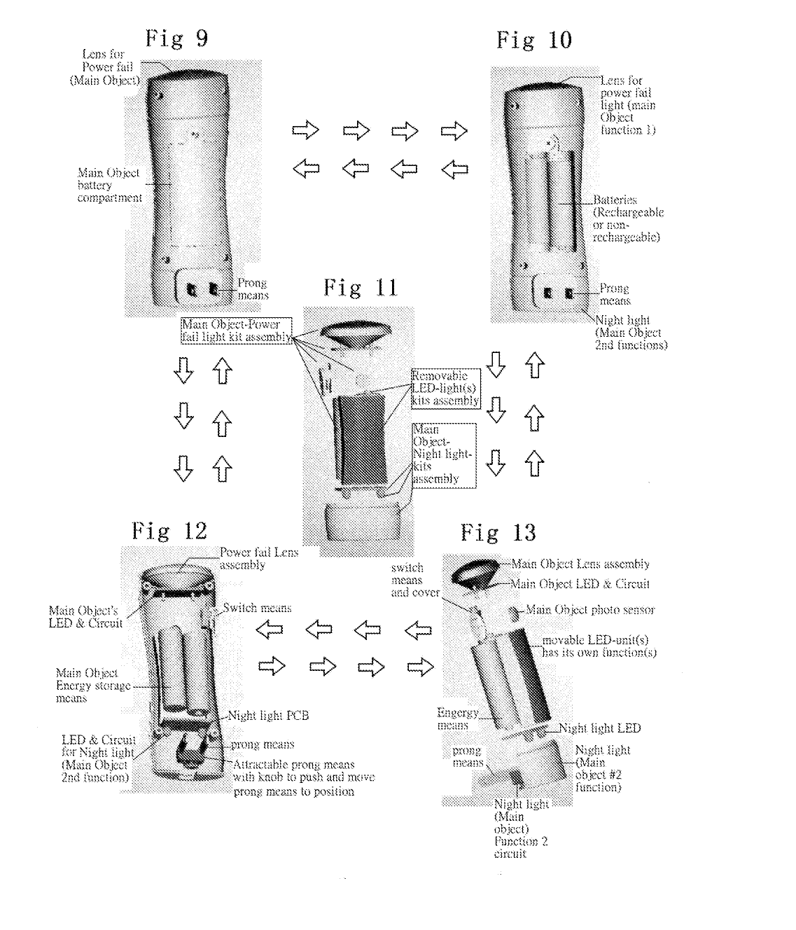

4. From FIG. 9, FIG. 10, FIG. 11, FIG. 12, FIG. 13 disclosure the back side of the FIG. 5, FIG. 6, FIG. 7, FIG. 8, so do not discuss here because the details drawing shown all details and assembly construction well from these drawings.

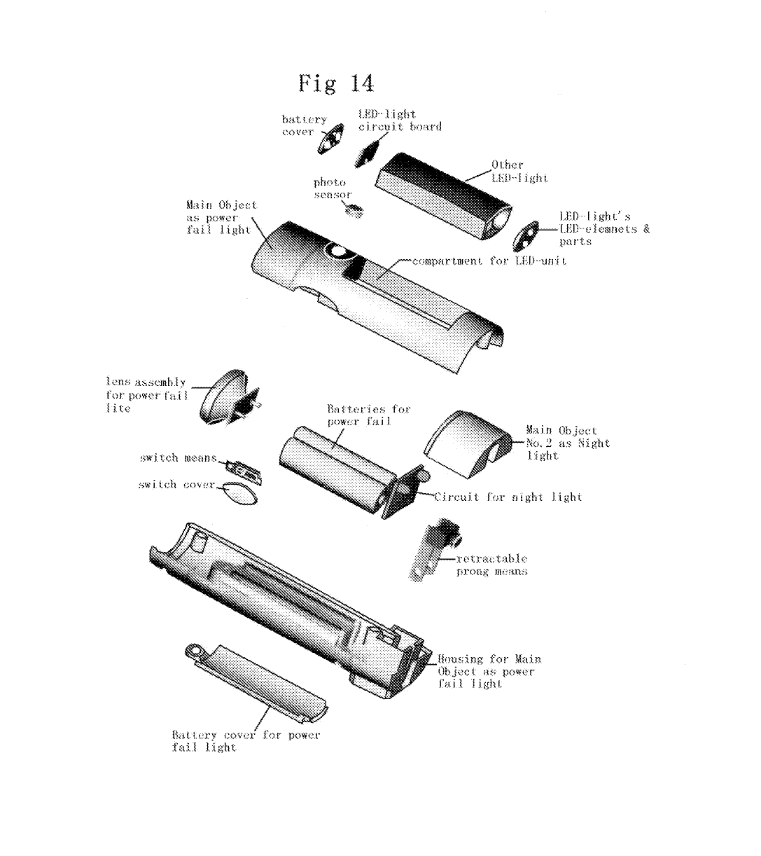

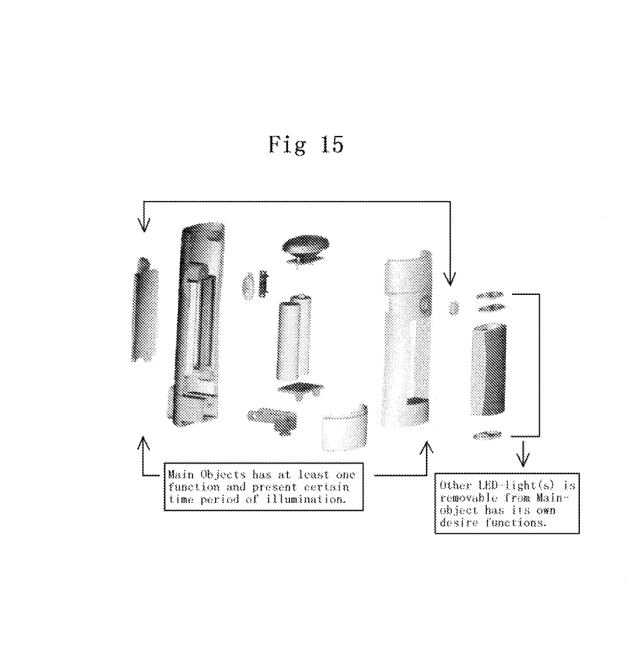

5. From FIG. 14 and FIG. 15 are 2 different viewing angle for the above listed embodiments. Because all parts & Accessories same as FIG. 5, FIG. 6, FIG. 7, FIG. 8 so do not discuss here more details.

For Quickly understanding the drawing and current invention's features, Please check below discussion:

### DETAILS DESCRIPTION

The current invention to make LED device with build-in removable LED-unit(s) with added functions as the above discuss back ground and Drawings.

1 From FIG. 1 and FIG. 2 disclosure the LED device has build-in movable LED-light(s) which for preferred embodiment for a LED power fail Night light which has extractable prong means to connect with home electricity system to get power to make the said below LED night light turn on by photo sensor control and the main-object illumination is a top flash light which will turn on while power fail automatically, the build-in removable LED-light(s) is the center piece which can turn-on and turn-off by desired sensor means, switch means, motion sensor means, remote control means as discussed on above background and following details descriptions content.

2 From FIG. 2 and FIG. 3 disclosure the one of the preferred construction for the said main-object with its illumination design and the said build-in removable LED-unit(s) assembly and dis-assembly from the main-object.

3 From FIG. 5, FIG. 6, FIG. 7, FIG. 8 disclosure all details construction of the main object and has build-in removable LED-light(s). The said main may in a power fail night light, emergency light with build in night light which has all parts and accessories to show the preferable details and construction. The alternative or replaceable or equivalent function parts & accessories of above discussion, prior arts, co-pending skill or method still fall within the current scope of invention.

4 From FIG. 9, FIG. 10, FIG. 11, FIG. 12, FIG. 13 disclosure the back side of the FIG. 5, FIG. 6, FIG. 7, FIG. 8, so do not discuss here because the details drawing shown all details and assembly construction well from these drawings.

5 From FIG. 14 and FIG. 15 are 2 different viewing angle for the above listed embodiments. Because all parts & Accessories same as FIG. 5, FIG. 6, FIG. 7, FIG. 8 so do not discuss here more details.

The features and unique design for current invention as below listed point by points:

1. The LED Device has build-in removable LED-lights consist of ;

At least has one main-object has build-in LED element(s) and the said main-object offer desire illumination while incorporate with parts & accessories selected from group combination of circuit means, Integrated circuit means (hereafter as IC), switch means, sensor means, motion sensor means, remote control means, blue tooth means, conductive means, energy storage means, rechargeable batteries, non-rechargeable batteries, batteries, energy storage means, solar power, chemical power, mechanical power, generator means, mechanical or electric means to generate the power means, motion electric generator(s), prong-means, resilient conductive means, contact means, screw base means, lamp holder plug means, lamp holder receiving means, conductive-means, wire and plug means, adaptor means, transformer means, or any kind of means which can get power to make the said LED-elements for illumination under pre-determined effects, functions, performance.

At least one of the LED-light can removable from the said main object at any time to offer illumination which the said main-object and removable-unit(s) has its power source which may same or different with main-object to offer desire illumination while incorporate with parts & accessories selected from group combination of circuit means, Integrated circuit means (hereafter as IC), switch means, sensor means, sensor means, remote control means, blue tooth means, conductive means, energy storage means, rechargeable batteries, non-rechargeable batteries, batteries, energy storage means, solar power, chemical power, mechanical power, generator means, mechanical or electric means to generate the power means, motion electric generator(s), prong-means, resilient conductive means, contact means, screw base means, lamp holder plug means, lamp holder receiving means, conductive-means, wire and plug means, adaptor means, transformer means, or any kind of means which can get power to make the said LED-elements for illumination under pre-determined effects, functions, performance.

The improvement including:

The said main-object has enough space, size, housing to build-in at least one more piece of LED-lights both the main-object and LED-lights has group functions select from motion sensor, power fail, emergency light, remote control, blue tooth remote control, timer, countdown, programmable timer, dimmer switch, touch switch, photos sensor switch, switch means, sensor means, IC means, color changing, fade-in and fade-out, night light, or any other LED light functions available from market available place.

The at least one or More than one removable LED-light(s) build in the said device which the device including the Flash light, Power fail light, LED bar, LED device, LED bulb, LED lamp holder, LED florescent tube, LED light bar, emergency light, evacuation light, night light, floor light, reading light, wall light, table lamp, desk lamp, indoor lighting, outdoor lighting,

The main-object has main illumination function(s) under predetermined design for period of time and other LED-light(s) as added illumination(s) while people operate under desire condition(s).

2. The LED Device has build-in removable LED-lights, the said Removable means the other LED-light(s) can be remove, assembly, dis-assembly from the said main-object.

3. The LED Device has build-in removable LED-lights, the said LED-element(s) can be any type, specification, shape, size, brightness, electric-terminal(s), electrode(s), viewing angle, color, power consumption rating for main-object or other LED-light(s).

4. The LED Device has build-in removable LED-lights, the said LED-element(s) can install, arrange, fix, put, soldering, surface mounting on the related electric parts & accessories for desired illumination.

5. The LED Device has build-in removable LED-lights, the said Main-object has its individual light functions as market available any type LED light device has build-in number of the said function(s), LED-element(s), effects(es), performance(s).

6. The LED Device has build-in removable LED-lights as claim 1, the said LED-units can be rechargeable by the inductor charging part & accessories build inside the said LED-unit(s) and the said main-object

7. The LED Device has build-in removable LED-lights as claim 1, the said inductor charging system which no need has physics electric parts or accessories to real contact which the said LED-unit(s) can be charged by magnetic passing though the plastic, isolated, non-conductive piece by the said inductive parts & accessories.

8. The LED Device has build-in removable LED-lights as claim 1, the said removable LED-lights which means has more than one of the LED-lights which at least one of the said LED-lights can be removable from the said LED Device.

1. The LED Device has build-in removable LED-lights consist of;
At least has one main-object has build-in LED element(s) to offer desire illumination while incorporate with parts & accessories selected from group combination of circuit means, Integrated circuit means (hereafter as IC), switch means, sensor means, sensor means, remote control means, blue tooth means, conductive means, energy storage means, rechargeable batteries, inductor charging parts & accessories, non-rechargeable batteries, batteries, energy storage means, solar power, chemical power, mechanical power, generator means, mechanical or electric means to generate the power means, motion electric generator(s), prong-means, resilient conductive means, contact means, screw base means, lamp holder plug means, lamp holder receiving means, conductive-means, wire and plug means, adaptor means, transformer means, or any kind of means which can get power to make the said LED-elements for illumination under pre-determined effects, functions, performance.
At least one of the LED-light can removable from the said main object at any time to offer illumination which the said main-object and removable-unit(s) has its power source which may same or different with main-object to offer desire illumination while incorporate with parts & accessories selected from group combination of circuit means, Integrated circuit means (hereafter as IC), switch means, sensor means, sensor means, remote control means, blue tooth means, conductive means, energy storage means, rechargeable batteries, inductor charging parts & accessories, non-rechargeable batteries, batteries, energy storage means, solar power, chemical power, mechanical power, generator means, mechanical or electric means to generate the power means, motion electric generator(s), prong-means, resilient conductive means, contact means, screw base means, lamp holder plug means, lamp holder receiving means, conductive-means, wire and plug means, adaptor means, transformer means, or any kind of means which can get power to make the said LED-elements for illumination under pre-determined effects, functions, performance.
The improvement including:
The said main-object has enough space, size, housing to build-in at least one more piece of LED-lights both the main-object and LED-lights has group functions select from motion sensor, power fail, emergency light, remote control, blue tooth remote control, timer, countdown, programmable timer, dimmer switch, touch switch, photos sensor switch, switch means, sensor means, IC means, color changing, fade-in and fade-out, night light, or any other LED light functions available from market available place.
The At least one or more than one removable LED-light(s) build in the said device which the device has group function may select including the Flash light, Power fail light, LED bar, LED device, LED bulb, LED lamp holder, LED florescent tube, LED light bar, emergency light, evacuation light, night light, floor light, reading light, wall light, table lamp, desk lamp, indoor lighting, outdoor lighting,
The main-object has main illumination function(s) under predetermined design for period of time and other LED-light(s) as added illumination(s) while people operate under desire condition(s).

2. The LED Device has build-in removable LED-lights as claim 1, the said Removable means the other LED-light(s) can be remove, assembly, dis-assembly from the said main-object.

3. The LED Device has build-in removable LED-lights as claim 1, the said LED-element(s) can be any type, specification, shape, size, brightness, electric-terminal(s), electrode(s), viewing angle, color, power consumption rating for main-object or other LED-light(s).

4. The LED Device has build-in removable LED-lights as claim 1, the said LED-element(s) can install, arrange, fix, put, soldering, surface mounting on the related electric parts & accessories for desired illumination.

5. The LED Device has build-in removable LED-lights as claim 1, the said Main-object has its individual light functions as market available any type LED light device has build-in number of the said function(s), LED-element(s), effects(es), performance(s).

6. The LED Device has build-in removable LED-lights as claim 1, the said LED-units can be rechargeable by the inductor charging part & accessories build inside the said LED-unit(s) and the said main-object

7. The LED Device has build-in removable LED-lights as claim 1, the said inductor charging system which no need has physics electric parts or accessories to real contact which the said LED-unit(s) can be charged by magnetic passing though the plastic, isolated, non-conductive piece by the said inductive parts & accessories.

8. The LED Device has build-in removable LED-lights as claim 1, the said removable LED-lights which means has more than one of the LED-lights which at least one of the said LED-lights can be removable from the said LED Device.
